(19) United States
(12) Patent Application Publication
(10) Pub. No.: US 2026/0296930 A1
(43) Pub. Date: Oct. 1, 2026

(54) Compositions and Methods for Dewatering

(71) Applicant: Locus Solutions IPCo, LLC, Solon, OH (US)

(72) Inventors: Gabriela KNESEL, Solon, OH (US); Ronney SILVA, Solon, OH (US); Cathrine MONYAKE, Solon, OH (US); Juan CERVANTES, Solon, OH (US)

(21) Appl. No.: 18/880,452

(22) PCT Filed: Jul. 8, 2023
(86) PCT No.: PCT/US2023/069842

§ 371 Date: Dec. 31, 2024

Related U.S. Application Data
(60) Provisional application No. 63/388,020, filed on Jul. 11, 2022.
(60) Provisional application No. 63/503,225, filed on May 19, 2023.

(51) Int. Cl. C02F 1/68; C02F 1/00; C02F 1/34; C02F 103/10

(52) U.S. Cl. CPC C02F 1/68; C02F 1/001; C02F 1/34; C02F 2103/10; C02F 2209/003

(57) ABSTRACT

The subject invention provides safe, environmentally-friendly compositions and efficient methods for dewatering. More specifically, the subject invention provides compositions derived from microorganisms for dewatering, which can be used for increasing the rate of dewatering and/or the amount of dewatered particles.

### CROSS-REFERENCE TO RELATED APPLICATIONS

This application claims priority to U.S. Provisional Patent Application No. 63/388,020, filed Jul. 11, 2022, and No. 63/503,225, filed May 19, 2023, both of which are incorporated herein by reference in their entirety.

### BACKGROUND OF THE INVENTION

Efficiently removing deposits from the earth and reducing pollution associated with various mining and quarrying practices use methods of dewatering. During mining, dewatering agents can be added to separate solids from a liquid. Currently, dewatering of coarse particles involves water drainage based on centrifugal or gravitational principles using stationary or mechanical equipment, such as, for example screens, cone dewaterers, classifiers, scrapers, and hydrocyclones. Dewatering of ore concentrates is important to reduce the weight and transportation costs from the mill to the smelter, roaster, or other processing plant. Dewatering of tailings is also often required for compliance with environmental regulations or for efficient disposal.

Mining or excavating of rock, including quarrying, can result in the production of toxic waste pollution, including during the production of phosphate, coal, potash, tac, mica, and bentonite. The mining and subsequent production of products often uses slurries that contain the mineral, element, or other material of interest. These slurries can further contain suspended or colloidal particles that may be toxic if released into the environments, such as, for example phosphatic clay waste or coal-clay waste. Additionally, the presence of the liquid can prevent efficient disposal of toxic waste.

In addition to the use of dewatering agents for mining, a dewatering agent is used in paper making, and for treating sewage sludge from municipal wastewater or stormwater. However, with conventional dewatering agents, the amount of treatable sludge is limited, and the treatment conditions may not be satisfactory in terms of the water content of a dewatered cake, the recovery rate, and the removability of a cake from filter cloth.

Therefore, novel, improved compositions and methods are needed for dewatering.

### BRIEF SUMMARY OF THE INVENTION

The subject invention relates generally to dewatering compositions and methods of using said compositions. More specifically, the subject invention provides environmentally-friendly dewatering compositions and methods for dewatering, such as, for example, during mining, beneficiation processes, construction, and wastewater treatment. In certain embodiments, existing methods can incorporate the subject compositions and methods.

Advantageously, the compositions and methods of the subject invention increase the efficiency of dewatering and can decrease the chemical usage, including chemical surfactant usage, required for dewatering. Accordingly, the subject invention can be useful for reducing the time needed for mining, water treatment (e.g., mining wastewater, municipal wastewater, stormwater, industrial wastewater) or production of various products, including, for example, paper or oil.

In certain embodiments, the subject invention provides compositions comprising components that are derived from microorganisms. In certain embodiments, the composition comprises a microbial biosurfactant. In certain embodiments, the composition comprises one or more biosurfactants, and, optionally, other compounds, such as, for example, water; chemical surfactants, including, for example, cetyltrimethyl ammonium bromide (CTAB); polymers, including, for example, polymeric ferric sulfate and polyacrylamide; flocculants, including, for example, chitosan; clarifying agents; coagulants; filtration aids; defoaming agents; inorganic salts, including, for example, aluminum (e.g., alum), iron, magnesium, and calcium salts; or any combination thereof.

In certain embodiments, the biosurfactant of the composition is utilized in crude form. The crude form can comprise, in addition to the biosurfactant, fermentation broth in which a biosurfactant-producing microorganism was cultivated, residual microbial cell matter or live or inactive microbial cells, residual nutrients, and/or other microbial growth by-products.

In some embodiments, the biosurfactant is utilized after being extracted from a fermentation broth and, optionally, purified.

The biosurfactant according to the subject invention can be a glycolipid (e.g., sophorolipids, rhamnolipids, cellobiose lipids, mannosylerythritol lipids and trehalose lipids), lipopeptide (e.g., surfactin, iturin, fengycin, arthrofactin, and lichenysin), flavolipid, phospholipid (e.g., cardiolipins), fatty acid ester compound, fatty acid ether compound, and/or high molecular weight polymers such as lipoproteins, lipopolysaccharide-protein complexes, and polysaccharide-protein-fatty acid complexes.

In certain specific embodiments, the biosurfactant is a sophorolipid (SLP), including linear SLP, lactonic SLP, acetylated SLP, de-acetylated SLP, salt-form SLP, esterified SLP derivatives, amino acid-SLP conjugates, and other SLP derivatives or isomers that exist in nature and/or are produced synthetically. In preferred embodiments, the SLP is a linear SLP or a derivatized linear SLP.

In certain embodiments, the subject invention provides a method for dewatering, wherein the method comprises the following steps:
a) contacting a dewatering composition comprising a biosurfactant with a liquid containing a solid or a semisolid particle; and
b) removing water from the solid or semisolid particle in the liquid.

In certain embodiments, the removal of the water can be performed using centrifugation, filtering, using gravitational principles, or any combination thereof, including, for example, plate and frame filter press or a belt filter press.

In some embodiments, the method enhances or increases the rate of dewatering and/or the amount dewatered particles that can be less than about 1 mm, about 500 μm, about 100 μm, about 10 μm, about 1 μm, about 100 nm, about 10 nm, or about 1 nm in diameter.

In some embodiments, the method comprises contacting a dewatering composition comprising a biosurfactant and, optionally, other components, such as, for example water chemical surfactants, polymers, flocculants, clarifying agents, coagulants, filtration aids, defoaming agents, or inorganic salts. In certain embodiments, the dewatering composition can be applied to the liquid for a period of time and/or until a distinct volume of the composition has been applied. The step can be repeated as many times as necessary to achieve a rate of dewatering or until a desired amount of water or liquid is removed from the solid or semisolid particle.

In certain embodiments, the dewatering composition according to the subject invention is effective due to enhancing and/or increasing the rate of agglomeration or total amount of the dewatered particles from a liquid containing of a colloidal suspension of said particles before the physical removal of the water occurs. For example, in some embodiments, a sophorolipid will form a micelle containing or linking the particles, wherein the micelle is less than 500 μm, less than 100 μm, less than 10 μm, less than 1 μm, less than 100 nm, less than 50 nm, less than 25 nm, less than 15 nm or less than 10 nm in size.

In certain embodiments, the methods of the subject invention result in at least a 25% increase in dewatering of particles, preferably at least a 50% increase, after one treatment. In certain embodiments, the liquid composition can be treated multiple times to further increase the amount of dewatered particles.

Advantageously, in certain embodiments, the dewatering composition according to the subject invention can be effective at dewatering toxic liquids. Furthermore, the methods of the subject invention do not require complicated equipment or high energy consumption, and production of the composition can be performed on site, for example, at a mine or at a wastewater treatment facility.

### DETAILED DESCRIPTION

The subject invention relates generally to the dewatering of particles. More specifically, the subject invention provides environmentally-friendly compositions and methods for dewatering, such as, for example, dewatering liquids that are produced at mining sites, wastewater, and water derived from industrial activities. Accordingly, the subject invention is useful for improving the efficiency and efficacy of methods of dewatering. Advantageously, the compositions and methods of the subject invention increase the dewatering of particles using safe, environmentally-friendly compositions.

### Selected Definitions

As used herein, “applying” a composition or product refers to contacting it with a target or site such that the composition or product can have an effect on that target or site. The effect can be due to, for example, microbial growth and/or the action of a biosurfactant or other microbial growth by-product.

As used herein, a “biofilm” is a complex aggregate of microorganisms, such as bacteria, yeast, or fungi, wherein the cells adhere to each other and/or to a surface using an extracellular matrix. The cells in biofilms are physiologically distinct from planktonic cells of the same organism, which are single cells that can float or swim in liquid medium.

As used herein, an “isolated” or “purified” nucleic acid molecule, polynucleotide, polypeptide, protein or organic compound such as a small molecule (e.g., those described below), is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. An isolated microbial strain means that the strain is removed from the environment in which it exists in nature. Thus, the isolated strain may exist as, for example, a biologically pure culture, or as spores (or other forms of the strain) in association with a carrier.

In certain embodiments, purified compounds are at least 60% by weight the compound of interest. Preferably, the preparation is at least 75%, more preferably at least 90%, and most preferably at least 98%, by weight the compound of interest. For example, a purified compound is one that is at least 80%, 85%, 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism or a substance necessary for taking part in a particular metabolic process. A metabolite can be an organic compound that is a starting material, an intermediate in, or an end product of metabolism. Examples of metabolites include, but are not limited to, enzymes, acids, solvents, alcohols, proteins, vitamins, minerals, microelements, amino acids, biopolymers and biosurfactants.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19 and 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein a “reduction” means a negative alteration, and an “increase” means a positive alteration, wherein the negative or positive alteration is at least 0.001%, 0.01%, 0.1%, 0.5%, 1%, 5%, 10%, 15%, 20%, 25%, 30%, 35%, 40%, 45%, 50%, 55%, 60%, 65%, 70%, 75%, 80%, 85%, 90%, 95% or 100%.

As used herein, “surfactant” means a compound that lowers the surface tension (or interfacial tension) between two liquids or between a liquid and a solid. Surfactants act as, e.g., detergents, wetting agents, emulsifiers, foaming agents, and/or dispersants. A “biosurfactant” is a surface-active substance produced by a living cell and/or using naturally-derived substrates.

Biosurfactants are a structurally diverse group of surface-active substances consisting of two parts: a polar (hydrophilic) moiety and non-polar (hydrophobic) group. Due to their amphiphilic structure, biosurfactants can, for example, increase the surface area of hydrophobic water-insoluble substances, increase the water bioavailability of such substances, and change the properties of bacterial cell surfaces. Biosurfactants can also reduce the interfacial tension between water and oil and, therefore, lower the hydrostatic pressure required to move entrapped liquid to overcome the capillary effect. Biosurfactants accumulate at interfaces, thus reducing interfacial tension and leading to the formation of aggregated micellar structures in solution. The formation of micelles provides a physical mechanism to mobilize, for example, oil in a moving aqueous phase.

The ability of biosurfactants to reduce the surface tension also permits their use as antibacterial, antifungal, and hemolytic agents to, for example, control pests and/or microbial growth.

Typically, the hydrophilic group of a biosurfactant is a sugar (e.g., a mono-, di-, or polysaccharide) or a peptide, while the hydrophobic group is typically a fatty acid. Thus, there are countless potential variations of biosurfactant molecules based on, for example, type of sugar, number of sugars, size of peptides, which amino acids are present in the peptides, fatty acid length, saturation of fatty acids, additional acetylation, additional functional groups, esterification, polarity and charge of the molecule.

These variations lead to a group of molecules comprising a wide variety of classes, including, for example, glycolipids (e.g., sophorolipids, rhamnolipids, cellobiose lipids, mannosylerythritol lipids and trehalose lipids), lipopeptides (e.g., surfactin, iturin, fengycin, arthrofactin and lichenysin), flavolipids, phospholipids (e.g., cardiolipins), fatty acid ester compounds, and high molecular weight polymers such as lipoproteins, lipopolysaccharide-protein complexes, and polysaccharide-protein-fatty acid complexes. Each type of biosurfactant within each class can further comprise subtypes having further modified structures.

Like chemical surfactants, each biosurfactant molecule has its own HLB value depending on its structure; however, unlike production of chemical surfactants, which results in a single molecule with a single HLB value or range, one cycle of biosurfactant production typically results in a mixture of biosurfactant molecules (e.g., subtypes and isomers thereof).

The phrases “biosurfactant” and “biosurfactant molecule” include all forms, analogs, orthologs, isomers, and natural and/or anthropogenic modifications of any biosurfactant class (e.g., glycolipid) and/or subtype thereof (e.g., sophorolipid).

As used herein, the term “sophorolipid,” “sophorolipid molecule,” “SLP” or “SLP molecule” includes all forms, and isomers thereof, of SLP molecules, including, for example, acidic (linear) SLP (ASL) and lactonic SLP (LSL). Further included are mono-acetylated SLP, di-acetylated SLP, esterified SLP, SLP with varying hydrophobic chain lengths, cationic and/or anionic SLP with fatty acid-amino acid complexes attached, esterified SLP, SLP-metal complexes, SLP-salt derivatives (e.g., a sodium salt of a linear SLP), and other, including those that are and/or are not described within in this disclosure.

In certain embodiments, the glycolipid biosurfactant is a sophorolipid (SLP). Sophorolipids are glycolipid biosurfactants produced by, for example, various yeasts of the Starmerella clade when cultivated in the presence of a hydrocarbon-based source of one or more fatty acids. SLP typically consist of a disaccharide sophorose linked to long chain hydroxy fatty acids. They can comprise a partially acetylated 2-O-β-D-glucopyranosyl-D-glucopyranose unit attached β-glycosidically to 17-L-hydroxyoctadecanoic or 17-L-hydroxy-Δ9-octadecenoic acid. The hydroxy fatty acid is generally 16 or 18 carbon atoms, and may contain one or more unsaturated bonds. Furthermore, the sophorose residue can be acetylated on the 6- and/or 6′-position(s). The fatty acid carboxyl group can be free (acidic or linear form (General Formula 2)) or internally esterified at the 4″-position (lactonic form (General Formula 1)). S. bombicola produces a specific enzyme, called S. bombicola lactone esterase, which catalyzes the esterification of linear SLP to produce lactonic SLP.

In preferred embodiments, the SLP according to the subject invention are represented by General Formula (1) and/or General Formula (2), and are obtained as a collection of 30 or more types of structural homologs:

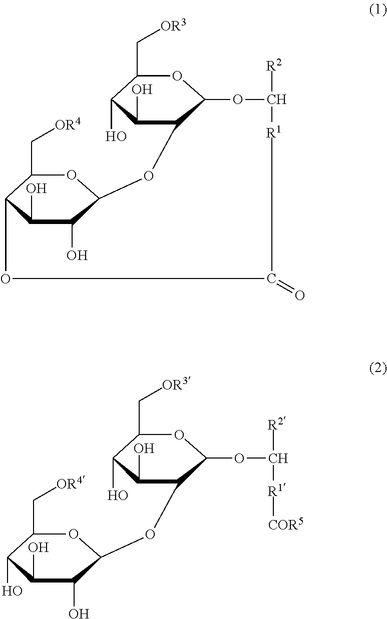

where R¹ and R^{1′} independently represent saturated hydrocarbon chains or single or multiple, in particular single, unsaturated hydrocarbon chains having 8 to 20, in particular 12 to 18 carbon atoms, more preferably 14 to 18 carbon atoms, which can be linear or branched and can comprise one or more hydroxy groups, R² and R^{2′} independently represent a hydrogen atom or a saturated alkyl functional group or a single or multiple, in particular single, unsaturated alkyl functional group having 1 to 9 carbon atoms, more preferably 1 to 4 carbon atoms, which can be linear or branched and can comprise one or more hydroxy groups, and R³, R^{3′}, R⁴ and R^{4′} independently represent a hydrogen atom or —COCH₃.

The composition utilized according to the subject methods can comprises more than one form of SLP, including linear SLP and lactonic SLP. The SLP can be non-acetylated, mono-acetylated and/or di-acetylated SLP.

In certain specific embodiments, the composition comprises SLP according to General Formula (1) (linear SLP) wherein R¹ and/or R² are an acetyl group, and wherein R³ is derived from a stearic, oleic and/or linoleic fatty acid.

SLP are typically produced by yeasts, such as Starmerella spp. yeasts and/or Candida spp. yeasts, e.g., Starmerella (Candida) bombicola, Candida apicola, Candida batistae, Candida floricola, Candida riodocensis, Candida stellate and/or Candida kuoi. SLP have environmental compatibility, high biodegradability, low toxicity, high selectivity and specific activity in a broad range of temperature, pH and salinity conditions. Additionally, in some embodiments, SLP can be advantageous due to their small micelle size, which can help facilitate the movement of the micelle, and compounds enclosed therein, through nanoscale pores and spaces. In certain embodiments, the micelle size of a SLP is less than 100 nm, less than 50 nm, less than 20 nm, less than 15 nm, less than 10 nm, or less than 5 nm.

In certain embodiments, the glycolipid is a rhamnolipid. Rhamnolipids comprise a glycosyl head group (i.e., a rhamnose) moiety, and a 3-(hydroxyalkanoyloxy)alkanoic acid (HAA) fatty acid tail, such as, e.g., 3-hydroxydecanoic acid. Two main subtypes of rhamnolipids exist, mono- and di-rhamnolipids, which comprise one or two rhamnose moieties, respectively. The HAA moiety can vary in length and degree of branching, depending on, for example, the growth medium and the environmental conditions. The highest accumulation of rhamnolipids (RLP) has been shown by submerged cultivation of Pseudomonas spp., such as P. aeruginosa.

Rhamnolipids according to the subject invention can have the following structure, according to General Formula (3):

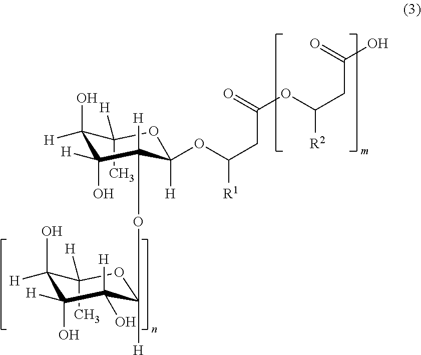

wherein m is 2, 1 or 0,
n is 1 or 0,
R¹ and R² are, independently of one another, the same or a different organic functional group having 2 to 24, preferably 5 to 13 carbon atoms, in particular a substituted or unsubstituted, branched or unbranched alkyl functional group, which can also be unsaturated,
wherein the alkyl functional group is a linear saturated alkyl functional group having 8 to 12 carbon atoms, or is a nonyl or a decyl functional group or a mixture thereof.

Salts of these compounds are also included according to the invention. In the present invention, the term “di-rhamnolipid” is understood to mean compounds of the above formula or the salts thereof in which n is 1. Accordingly, “mono-rhamnolipid” is understood in the present invention to mean compounds of the general formula or the salts thereof in which n is 0. In certain specific embodiments, the composition comprises a mixture of mono- and di-rhamnolipids.

As used herein, “dewatering” refers to the process by which water is removed from solids (i.e., suspended solids) or semisolid particles by, for example, reducing the amount of water in particles, yielding a cake.

As used herein, a “semisolid” or “quasi-solid” particle is a substance that has an intermediate viscosity and rigidity between that a liquid and a solid.

As used herein, “beneficiation” refers to the process by which gangue materials are removed from the product of interest (e.g., element, compound, mineral).

As used herein, “ore” refers to a naturally occurring solid material from which a valuable substance, mineral and/or metal can be profitably extracted. Ores are often mined from ore deposits, which comprise ore minerals containing the valuable substance. “Gangue” minerals are minerals that occur in the deposit but do not contain the valuable substance. Examples of ore deposits include hydrothermal deposits, magmatic deposits, laterite deposits, volcanogenic deposits, metamorphically reworked deposits, carbonatite-alkaline igneous related deposits, placer ore deposits, residual ore deposits, sedimentary deposits, sedimentary hydrothermal deposits and astrobleme-related deposits. Ores, as defined herein, however, can also include ore concentrates or tailings.

As used herein, “leaching” refers to the process by which metal is extracted from ore by aqueous solutions including by, for example, ammonia leaching, alkali leaching, acid leaching, cyanidation (i.e., cyanide leaching), or thiosulfate leaching. As used herein “cyanidation” refers to the process of converting gold in ore to a water-soluble coordination complex using aqueous cyanide, including, for example, sodium cyanide, potassium cyanide, or calcium cyanide.

As used herein, “colloid” or “colloidal particle” refers to a mixture in which one insoluble substance is dispersed or suspended throughout another substance. The insoluble substance is generally dispersed in a liquid.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Dewatering Compositions

In certain embodiments, the subject invention provides compositions comprising components that are derived from microorganisms. In certain embodiments, the composition comprises a microbial biosurfactant. In certain embodiments, the composition comprises one or more biosurfactants, and, optionally, other compounds, such as, for example, water, chemical surfactants, polymers, flocculants, clarifying agents, coagulants, filtration aids, defoaming agents, inorganic salts, or any combination thereof.

In certain embodiments, the chemical surfactant of the dewatering composition is a detergent, wetting agent, emulsifier, foaming agent, and/or dispersant. In certain embodiments, the chemical surfactants, include, for example, cetyltrimethyl ammonium bromide (CTAB).

In certain embodiments, the polymers can include natural or synthetic polymers, water soluble polymers, cationic polymers, anionic polymers, or non-ionic polymers. The polymers can be, for example, anionic polyacrylamide, modified polyacrylamide, nonionic polyacrylamide, starch, guar gum, Moringa oleifera seed extract, Strychnos potatorum seed extract, gelatin (e.g., isinglass), alginate (e.g., sodium alginate), or polymeric ferric sulfate.

In certain embodiments, the filtration aids include, for example, cellulose fibers, diatomaceous earth, charcoal, expanded perlite and asbestos fibers. Filtration aids can be chemicals that assist in solid-liquid separation by modifying the surface properties of minerals, elements, or other substances to enhance water repellency. The filtrations aids impart a hydrophobic character to particles so that interstitial water is reduced to a minimum. Flocculants constitute one type of filtration aid; by binding the ultrafine particles together, they prevent them from binding the filter medium. In certain embodiments, the flocculants include, for example, chitosan. In certain embodiments, water-absorbing polymers are used to immobilize water as a gel, thus improving the handling properties of a concentrate, although such a function is not strictly dewatering.

In certain embodiments, the inorganic salts include, for example, aluminum (e.g., alum), iron, magnesium, and calcium salts.

In certain embodiments, the dewatering composition comprises a microbe-based product comprising a biosurfactant utilized in crude form. The crude form can comprise, in addition to the biosurfactant, fermentation broth in which a biosurfactant-producing microorganism was cultivated, residual microbial cell matter or live or inactive microbial cells, residual nutrients, and/or other microbial growth by-products. The product may be, for example, at least, by weight, 1%, 5%, 10%, 25%, 50%, 75%, or 100% broth. The amount of biomass in the product, by weight, may be, for example, anywhere from 0% to 100% inclusive of all percentages therebetween.

In some embodiments, the biosurfactant is utilized after being extracted from a fermentation broth and, optionally, purified.

The biosurfactant according to the subject invention can be a glycolipid (e.g., sophorolipids, rhamnolipids, cellobiose lipids, mannosylerythritol lipids and trehalose lipids), lipopeptide (e.g., surfactin, iturin, fengycin, arthrofactin and lichenysin), flavolipid, phospholipid (e.g., cardiolipins), fatty acid ester compound, fatty acid ether compound, and/or high molecular weight polymers such as lipoproteins, lipopolysaccharide-protein complexes, and polysaccharide-protein-fatty acid complexes.

In certain specific embodiments, the biosurfactant is a sophorolipid (SLP), including linear SLP, lactonic SLP, acetylated SLP, de-acetylated SLP, salt-form SLP derivatives, esterified SLP derivatives, amino acid-SLP conjugates, and other SLP derivatives or isomers that exist in nature and/or are produced synthetically. In preferred embodiments, the SLP is a linear SLP or a derivatized linear SLP. In certain embodiments, the subject compositions can comprise lactonic and linear SLP, with at least about 50%, about 55%, about 60%, about 65%, about 70%, about 75%, about 80%, about 85%, about 90%, or about 95% of the SLP comprising linear forms, and the remainder comprising lactonic forms.

In some embodiments, the biosurfactant can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total dewatering composition.

In another embodiment, a purified biosurfactant may be added in combination with an acceptable carrier, in that the biosurfactant may be presented at concentrations of 0.001 to 50% (v/v), preferably, 0.01 to 20% (v/v), more preferably, 0.02 to 5% (v/v).

In some embodiments, the biosurfactant can be included in the composition at, for example, 0.01 to 100,000 ppm, 0.05 to 10,000 ppm, 0.1 to 1,000 ppm, 0.5 to 750 ppm, 1.0 to 500 ppm, 2.0 to 250 ppm, or 3.0 to 100 ppm, with respect to the amount of liquid being treated.

In certain embodiments, the chemical surfactant of the dewatering composition is a detergent, wetting agent, emulsifier, foaming agent, and/or dispersant. In some embodiments, the chemical surfactant can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total dewatering composition.

The dewatering composition can further comprise other additives such as, for example, carriers, other microbe-based compositions, additional biosurfactants, enzymes, catalysts, solvents, salts, buffers, chelating agents, acids, emulsifying agents, lubricants, solubility controlling agents, preservatives, stabilizers, ultra-violet light resistant agents, viscosity modifiers, preservatives, tracking agents, and other microbes and other ingredients specific for an intended use.

In certain embodiments, chelating agents can be, but are not limited to, ethylenediaminetetraacetic acid (EDTA), nitrilotriacetic acid (NTA), a phosphonate, succimer (DMSA), diethylenetriaminepentaacetate (DTPA), N-acetylcysteine, n-hydroxyethylethylenediaminetriacetic acid (HEDTA), organic acids with more than one coordination group (e.g., rubeanic acid), STPP (sodiumtripolyphosphate, Na5P3O10), trisodium phosphate (TSP), water, carbohydrates, organic acids with more than one coordination group (e.g., citric acid), lipids, steroids, amino acids or related compounds (e.g., glutathione), peptides, phosphates, nucleotides, tetrapyrrols, ferrioxamines, ionophores, orphenolics, sodium citrate, sodium gluconate, ethylenediamine disuccinic acid (EDDS), iminodisuccinic acid (IDS), L-glutamic acid diacetic Acid (GLDA), GLDA-Na4, methyl glycindiacetic acid (MGDA), polyaspartic acid (PASA), hemoglobin, chlorophyll, lipophilic β-diketone, and (14,16)-hentriacontanedione, ethylenediamine-N,N′-diglutaric acid (EDDG), ethylenediamine-N,N′-dimalonic acid (EDDM), 3-hydroxy-2,2-iminodisuccinic acid (HIDS), 2-hydroxyethyliminodiacetic acid (HEIDA), pyridine-2,6-dicarboxylic acid (PDA), trimethyl glycine (TMG), Tiron, or any combination thereof.

### Methods of Dewatering

In certain embodiments, the subject invention provides a method for dewatering solids or semisolids from various sources, including, for example, mining sites, quarrying sites, wastewater sites, agricultural sites, and industrial sites.

In certain embodiments, the subject invention provides a method for dewatering tailings from mines. The method comprises adding the subject compositions to the tailings and removing the water from solid or semisolid particles. By dewatering the tailings, the particles can reach a higher concentration when dewatered. In preferred embodiments, the tailings are low-grade tailings, in which the tailings comprise less than about 50%, about 40%, about 35%, about 30%, or about 25% of the product of interest (e.g., metal, mineral, compound or element being mined), with the remainder comprising gangue.

In certain embodiments, the mining site can be a coal mine, iron ore mine (e.g., taconite), copper mine, copper-nickel mine, tin mine, nickel mine, gold mine, silver mine, molybdenum mine, aluminum mine (e.g., bauxite mine, kyanite mine), lead-zinc mine, tungsten mine, phosphate mine, potash mine, mica mine, bentonite mine, or zinc mine. The mine can be an underground mine, surface mine, placer mine or in situ mine. In certain embodiments, a variety of toxic compounds can be derived from mining activities. In certain embodiments, methods of removing said toxic compounds are provided according to the subject methods by contacting the dewatering compounds to various water streams, piping, pumps, water storage areas, or other aquatic environments. The toxic compounds can include, for example, cyanide, sulfur-bearing minerals, soluble iron, and heavy metals, such as, for example, molybdenum, tungsten, chromium, manganese, nickel, arsenic, and vanadium. In certain embodiments, the quarrying site can extract chalk, clay, cinder, coal, sand, gravel, coquina, diabase, gabbro, granite, gritstone, gypsum, limestone, marble, ores, phosphate rock, quartz, sandstone, slate, travertine, or any combination thereof.

In certain embodiments, water can be pumped or otherwise added to the geological formation containing the element, mineral, compound, or other material of interest before the mineral, compound, or other material of interest is extracted. In certain embodiments, the subject compositions and methods can be used to dewater the extracted slurries.

In certain embodiments, the subject compositions and methods can be used to extract a liquid from a mining or quarrying site by applying the composition to the liquid at the site before the liquid is pumped or otherwise removed from the site. In certain embodiments, the source of the water at the mining or quarrying site can be groundwater or precipitation.

In certain embodiments, the microbe-containing and/or biosurfactant-containing composition can improve agglomeration between the particles or particles and a surface, such as, for example, agglomerating coal mining toxic byproducts to each other.

In certain embodiments, the subject methods and compositions can alter the surface tension of the liquids containing solid particles from a source, such as, for example, a coal mine. In certain embodiments, the biosurfactant-containing compositions can interact with the surface and interior of solids, such as, for example, coal within the liquid. In certain embodiments, the biosurfactant can reduce the surface tension of the liquid, reduce the interfacial tension between the liquid and the solid particles, increase in hydrophobicity of the solid, or a combination thereof, which can increase the efficiency of dewatering, by, for example, allowing a greater reduction in the moisture content of the dewatered particle relative to a dewatered solid that has not been contacted to a dewatering composition of the subject invention. In certain embodiments, the efficiency of dewatering can be increased by at least about 5%, 10%, 15%, or about 25%.

In certain embodiments, the subject methods can be used to dewater fine coal. In certain embodiments, fine coal comprises coal particles less than about 0.5 mm in diameter. Without dewatering, the fine coal can have a high moisture content that can reduce the heat content of the coal and can increase the cost of transportation of the coal. In certain embodiments, the dewatering of fine coal comprises mixing fine coal with coarse coal (e.g., larger than 0.5 mm in diameter), contacting the fine and coarse coal to a dewatering composition of the subject invention, and filtering, centrifuging, gravity separating, or otherwise separating the water from the coal.

In certain embodiments, the microbe-containing and/or biosurfactant-containing composition can form a layer of agglomerated particulate around and/or between particles suspended in a liquid.

The compositions can be applied to liquids or vessels that contain liquids that reside at a range of temperatures and aquatic environments, such as, for example, a stream, river, waterway, ocean, sea, lake, pond, runoff area, containment ponds, piping, centrifuge, filter, press, screen, cone, dewaterer, classifier, scraper, hydrocyclone, agitator, drum, disk, or wastewater treatment/holding tank. In certain embodiments, the dewatering composition can be added to the vessels that contain liquids before the liquid composition is added to said vessel.

The dewatering composition can be applied to a liquid and, optionally, mixed by adding, pouring, or combining.

In certain embodiments, the time period in which the dewatering composition can be contacted to a liquid or vessel is for about 1 second to about 1 year, about 1 minute to about 1 year, about 1 minute to about 6 months, about 1 minute to about 1 month, about 1 minute to about 1 week, about 1 minute to about 48 hours, about 30 minutes to 40 hours, or preferably about 12 hours to 24 hours. In certain embodiments, the methods comprise applying a liquid or solid form of the dewatering composition to the liquid for the period of time in which liquid containing suspended particles is being produced or until the amount of liquid has been reduced to an amount that is determined to be satisfactory or safe, which can be readily determined by one skilled in the art. The amount of water that may be considered acceptable and/or safe depends on the context. For example, the amount of dewatering of particles may be acceptable in lower amounts at mining sites that do not contain toxic compounds than in mining sites that produced toxic compounds, which require expensive disposal methods. Therefore, removing substantial amounts of water from toxic compounds before disposal can reduce costs.

In certain embodiments, the amount of the dewatering composition applied is about 0.00001 to 15%, about 0.00001 to 10%, about 0.0001 to 5%, about 0.001 to 3%, about 0.01%, or about 1 vol % based on an amount of liquid that is treated.

In certain embodiments, the methods of the subject invention result in at least a 25% increase in dewatering of particles, preferably at least a 50% increase, after one treatment. In certain embodiments, the liquid can be treated multiple times to further increase the amount of dewatered particles.

In certain embodiments, the dewatering composition according to the subject invention is effective due to amphiphiles-mediated adhesion of the suspended particles. In some embodiments, the sophorolipid or other biosurfactant serves as a vehicle for facilitating dewatering of particulate matter and/or adhesion of particulate matter to a surface and/or object. For example, in some embodiments, a sophorolipid will form a micelle containing a particle, wherein the micelle is less than 1 mm, 100 μm, 50 μm, 20 μm, 10 μm, 1 μm, 100 nm, less than 50 nm, less than 25 nm, less than 15 nm or less than 10 nm in size. The small size and amphiphilic properties of the micelle allow for enhanced adhesion of the particle so that greater agglomeration of particles can occur, allowing for a more efficient dewatering process to occur.

In certain embodiments, the dewatering compositions can be used in methods of processing ores, ore slurries, or other products obtained via mining. In certain embodiments, the dewatering compositions can be used for dewatering before grinding, concentrate dewatering, tailings dewatering, tailings filling, middling dewatering, or any combination thereof.

In certain embodiments, the dewatering compositions can be used in beneficiation processes, particularly in low-grade ores containing low concentrations of the element or other product of interest, such as, for example, gold or silver. In order to extract the element or compound of interest, it can be necessary to crush and grind the ore and preconcentrate or separate the element or product of interest from the ore by flotation or gravity separation (i.e., settling). In certain embodiments, the settling rate of concentrate can be accelerated, and the dewatering efficiency can be improved by adding the dewatering compositions during the beneficiation process.

In certain embodiments, the dewatering compositions can be used in methods of leaching, such as, for example, gold cyanidation. The process of extraction by leaching includes leaching (e.g., cyanide leaching), washing and filtering of leaching pulp, extraction of the metal from the leaching solution or pulp, and smelting of finished products.

In certain embodiments, the dewatering compositions can be used in methods of washing and filtering leaching pulp, in which the dewatering compositions increase the rate of dewatering of the leaching pulp. In certain embodiments, the dewatering compositions can dewater heavy metals and metalloids including, for example, As, Cd, Co, Cu, Hg, Mn, Ni, U, and Zn, in the mined tailings, which can present a significant potential ecological and human health risk associated with metal and metalloid exposure from contaminated soils around mined tailings storage sites.

In certain embodiments, the dewatering compositions can remove the pregnant solution from the leached solids during hydrometallurgical processes.

In certain embodiments, the dewatering composition can be used in methods of treating industrial sewage and sewage water containing water-soluble organic substances. The purification process uses activated sludge treatment for the removal of soluble organic substances. In certain embodiments, activated sludge treatment uses the growth of microorganisms for processing, so a dewatering treatment of sludge is often used to reduce water volumes. In certain embodiments, sludge dewatering can use traditional dewatering agents. In certain embodiments, the subject dewatering compositions can be used instead of synthetic polymer dewatering agents or in conjunction with polymer dewatering agents to agglomerate and dewater sludges. Cationic dewatering agents can neutralize negative charges on the surface of colloidal particles in sludge and can bridge between particles to form large and strong flocs for easily dewatering. Sludge containing flocs can be dehydrated by sludge-dewatering equipment, separated to solids called sludge cake, and disposed of by landfill, incineration, or compost. In certain embodiments, the dewatering methods can reduce the amount of water in the sludge by about at least about 50%, about 60%, about 70%, or about 80%.

In certain embodiments, the dewatering composition can be used in various industrial methods, including in the manufacturing or processing of food, beverages, oil sands, and paper. During the manufacturing of products, dewatering compositions can be used primarily in treating wastewater (e.g., to dewater a sludge), in which suspended particles, such as, for example, sludge, particles containing phosphates, and residual oil sands from oil sand tailings, are agglomerated and then the liquid is removed from the particle before the water is discharged or stored.

In certain embodiments, the subject composition can be used in methods of filtration, which are used to separate liquids from solids or semisolids more completely than settling alone can accomplish. It is used principally in dewatering flotation concentrates and tailings, such as, for example, in order to clarify a decanted solution; in collecting precipitated solids; or in removing pregnant solution from leached solids during hydrometallurgical processes.

Filtration usually consists of pneumatic techniques. Of the various types of filters, the most common is the vacuum filter. A vacuum is applied across a membrane cloth, horizontally mounted on rotating drums or rotating disks, the lower segments of which are immersed in pulp in a tank. The feed pulp or slurry is kept in suspension by rotary agitators. Pumps suck the liquid through the filter but leave the caked solids behind. Before the drum or disk reaches the tank again, the vacuum shuts off and pressurized air is applied to dislodge the filter cake, or alternatively, scrapers remove the filter cake into a discharge chute.

Advantageously, in certain embodiments, the dewatering composition according to the subject invention provides enhanced or increased efficiency of dewatering particles with limited negative environmental impacts. Additionally, the methods of the subject invention do not require complicated equipment or high energy consumption, and the production of the dewatering composition can be performed on site, including, for example, at a mine or at an industrial site. In certain embodiments, the subject dewatering composition can result in a decreased use of chemical surfactants, synthetic dewatering agents, or other potentially harmful chemicals used for dewatering.

### Production of Microbe-Based Products

In certain embodiments, the subject invention provides methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

The microorganisms can be, for example, bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In certain embodiments, the microbes are capable of producing amphiphilic molecules, enzymes, proteins and/or biopolymers. Microbial biosurfactants, in particular, are produced by a variety of microorganisms such as bacteria, fungi, and yeasts, including, for example, Agrobacterium spp. (e.g., A. radiobacter); Arthrobacter spp.; Aspergillus spp.; Aureobasidium spp. (e.g., A. pullulans); Azotobacter (e.g., A. vinelandii, A. chroococcum); Azospirillum spp. (e.g., A. brasiliensis); Bacillus spp. (e.g., B. subtilis, B. amyloliquefaciens, B. pumillus, B. cereus, B. licheniformis, B. firmus, B. laterosporus, B. megaterium); Blakeslea; Candida spp. (e.g., C. albicans, C. rugosa, C. tropicalis, C. lipolytica, C. torulopsis); Clostridium (e.g., C. butyricum, C. tyrobutyricum, C. acetobutyricum, and C. beijerinckii); Campylobacter spp.; Cornybacterium spp.; Cryptococcus spp.; Debaryomyces spp. (e.g., D. hansenii); Entomophthora spp.; Flavobacterium spp.; Gordonia spp.; Hansenula spp.; Hanseniaspora spp. (e.g., H. uvarum); Issatchenkia spp; Kluyveromyces spp.; Meyerozyma spp. (e.g., M. guilliermondii); Mortierella spp.; Mycorrhiza spp.; Mycobacterium spp.; Nocardia spp.; Pichia spp. (e.g., P. anomala, P. guilliermondii, P. occidentalis, P. kudriavzevii); Phycomyces spp.; Phythium spp.; Pseudomonas spp. (e.g., P. aeruginosa, P. chlororaphis, P. putida, P. florescens, P. fragi, P. syringae); Pseudozyma spp. (e.g., P. aphidis); Ralslonia spp. (e.g., R. eulropha); Rhodococcus spp. (e.g., R. erythropolis); Rhodospirillum spp. (e.g., R. rubrum); Rhizobium spp.; Rhizopus spp.; Saccharomyces spp. (e.g., S. cerevisiae, S. boulardii sequela, S. torula); Sphingomonas spp. (e.g., S. paucimobilis); Starmerella spp. (e.g., S. bombicola); Thraustochytrium spp.; Torulopsis spp.; Ustilago spp. (e.g., U. maydis); Wickerhamomyces spp. (e.g., W. anomalus); Williopsis spp.; and/or Zygosaccharomyces spp. (e.g., Z. bailii).

In preferred embodiments, microorganism is a Starmerella spp. yeast and/or Candida spp. yeast, e.g., Starmerella (Candida) bombicola, Candida apicola, Candida batistae, Candida floricola, Candida riodocensis, Candida stellate and/or Candida kuoi. In a specific embodiment, the microorganism is Starmerella bombicola, e.g., strain ATCC 22214.

As used herein “fermentation” refers to cultivation or growth of cells under controlled conditions. The growth could be aerobic or anaerobic. In preferred embodiments, the microorganisms are grown using SSF and/or modified versions thereof.

In one embodiment, the subject invention provides materials and methods for the production of biomass (e.g., viable cellular material), extracellular metabolites (e.g., small molecules and excreted proteins), residual nutrients and/or intracellular components (e.g., enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, rice bran oil, olive oil, corn oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials in the medium before, and/or during the cultivation process. Antimicrobial agents or antibiotics are used for protecting the culture against contamination.

Additionally, antifoaming agents may also be added to prevent the formation and/or accumulation of foam during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

The microbial growth by-product produced by microorganisms of interest may be retained in the microorganisms or secreted into the growth medium. The medium may contain compounds that stabilize the activity of microbial growth by-product.

The biomass content of the fermentation medium may be, for example, from 5 g/l to 180 g/l or more, or from 10 g/l to 150 g/l.

The cell concentration may be, for example, at least 1×10⁶ to 1×10¹², 1×10⁷ to 1×10¹¹, 1×10⁸ to 1×10¹⁰, or 1×10⁹ CFU/ml.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

Advantageously, the method does not require complicated equipment or high energy consumption. The microorganisms of interest can be cultivated at small or large scale on site and utilized, even being still-mixed with their media.

In certain embodiments, the subject invention provides a “microbe-based composition,” meaning a composition that comprises components that were produced as the result of the growth of microorganisms or other cell cultures. Thus, the microbe-based composition may comprise the microbes themselves and/or by-products of microbial growth. The microbes may be in a vegetative state, in spore form, in mycelial form, in any other form of propagule, or a mixture of these. The microbes may be planktonic or in a biofilm form, or a mixture of both. The by-products of growth may be, for example, metabolites, cell membrane components, expressed proteins, and/or other cellular components. The microbes may be intact or lysed. The microbes may be present in or removed from the composition. The microbes can be present, with broth in which they were grown, in the microbe-based composition. The cells may be present at, for example, a concentration of at least 1×10³, 1×10⁴, 1×10⁵, 1×10⁶, 1×10⁷, 1×10⁸, 1×10⁹, 1×10¹⁰, 1×10¹¹, 1×10¹², 1×10¹³ or more CFU per milliliter of the composition.

The subject invention further provides “microbe-based products,” which are products that are to be applied in practice to achieve a desired result. The microbe-based product can be simply a microbe-based composition harvested from the microbe cultivation process. Alternatively, the microbe-based product may comprise further ingredients that have been added. These additional ingredients can include, for example, stabilizers, acids, buffers, carriers, such as water, salt solutions, or any other appropriate carrier, added nutrients to support further microbial growth, non-nutrient growth enhancers, and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

One microbe-based product of the subject invention is simply the fermentation medium containing the microorganisms and/or the microbial metabolites produced by the microorganisms and/or any residual nutrients. The product of fermentation may be used directly without extraction or purification. If desired, extraction and purification can be easily achieved using standard extraction and/or purification methods or techniques described in the literature.

The microorganisms in the microbe-based products may be in an active or inactive form, or in the form of vegetative cells, reproductive spores, conidia, mycelia, hyphae, or any other form of microbial propagule. The microbe-based products may also contain a combination of any of these forms of a microorganism.

In one embodiment, different strains of microbe are grown separately and then mixed together to produce the microbe-based product. The microbes can, optionally, be blended with the medium in which they are grown and dried prior to mixing.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers or otherwise transported for use. The additives can be, for example, buffers, carriers, other microbe-based compositions produced at the same or different facility, viscosity modifiers, preservatives, nutrients for microbe growth, surfactants, emulsifying agents, lubricants, solubility controlling agents, tracking agents, solvents, biocides, antibiotics, pH adjusting agents, chelators, stabilizers, ultra-violet light resistant agents, other microbes and other suitable additives that are customarily used for such preparations.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C. On the other hand, a biosurfactant composition can typically be stored at ambient temperatures.

1. A method of dewatering, the method comprising:
a) contacting a dewatering composition comprising a biosurfactant with a liquid containing a solid or a semisolid particle; and
b) removing water from the solid or semisolid particle in the liquid, yielding a dewatered particle.

2. The method of claim 1, wherein removing water comprises filtering, centrifugation, settling, or any combination thereof.

3. The method of claim 1, wherein the filtering comprises using a plate and frame filter press or a belt filter press.

4. The method of claim 1, wherein the filtering comprises applying a vacuum across a filter.

5. The method of claim 1, wherein the liquid is a wastewater or a slurry of ore.

6. The method of claim 5, wherein the wastewater is municipal wastewater, stormwater, mining wastewater, quarrying wastewater, groundwater, precipitation, or industrial wastewater.

7. The method of claim 5, wherein the wastewater or slurry of ore is from a coal mine, iron ore mine, copper mine, copper-nickel mine, tin mine, nickel mine, gold mine, silver mine, molybdenum mine, aluminum mine, lead-zinc mine, tungsten mine, phosphate mine, potash mine, mica mine, bentonite mine, or zinc mine.

8. The method of claim 7, wherein the aluminum mine is a kyanite mine or a bauxite mine.

9. The method of claim 1, wherein the dewatering composition further comprises a chemical surfactant, polymer, flocculant, clarifying agent, coagulant, filtration aid, defoaming agent, inorganic salt, or any combination thereof.

10. (canceled)

11. The method of claim 1, wherein the biosurfactant is a sophorolipid and/or a yeast culture comprising a sophorolipid.

12. The method of claim 11, wherein the yeast culture is a Starmerella sp. and/or a Candida sp. yeast.

13. The method of claim 11, wherein the yeast is in a vegetative state.

14. The method of claim 11, wherein the yeast is in a spore form.

15. The method of claim 1, wherein the dewatering comprises removing water from the solid or semisolid particle by one or a combination of the following:
a) adhering the particle to a surface and/or object;
b) agglomerating particles together;
c) settling the particle;
d) reducing the surface tension of the liquid; or
e) reducing the interfacial tension between the liquid and the solid or the semisolid particle.

16. The method of claim 1, further comprising:
c) measuring the moisture content of the dewatered particle.

17. The method of claim 16, wherein the moisture content of the dewatered particle is less than a dewatered particle that has not been contacted with the biosurfactant.

18. A dewatering composition comprising a sophorolipid and/or a yeast culture comprising a sophorolipid and one or more traditional dewatering components, wherein the traditional dewatering components are selected from one or a combination of the following:
a) chemical surfactant;
b) polymer;
c) flocculant;
d) filtration aids,
e) defoaming agent,
f) clarifying agent;
g) coagulant; or
h) inorganic salt.

19. The composition of claim 18, wherein the yeast culture is a Starmerella sp. and/or a Candida sp. yeast.

20. The composition of claim 18, wherein the yeast is in a vegetative state.

21. The composition of claim 18, wherein the yeast is in a spore form.

22. (canceled)
